(19) United States
(12) Patent Application Publication
(10) Pub. No.: US 2022/0100919 A1
(43) Pub. Date: Mar. 31, 2022

(54) PROBABILISTIC FATIGUE AND BLEND LIMIT ASSESSMENT AND VISUALIZATION METHODS FOR AIRFOILS

(71) Applicant: General Electric Company, Schenectady, NY (US)

(72) Inventors: Suryarghya Chakrabarti, Evendale, OH (US); Kevin Turner, Evendale, OH (US); Yoon Seok Choi, Evendale, OH (US); Douglas L. Washburn, Evendale, OH (US); Liping Wang, Niskayuna, NY (US); Andrew J. Blair, Evendale, OH (US)

(73) Assignee: General Electric Company, Schenectady, NY (US)

(21) Appl. No.: 17/232,540

(22) Filed: Apr. 16, 2021

Related U.S. Application Data
(60) Provisional application No. 63/085,430, filed on Sep. 30, 2020.

(51) Int. Cl. G06F 30/17; G06F 30/27; G06N 7/00

(52) U.S. Cl. CPC G06F 30/17; G06F 2111/08; G06N 7/005; G06F 30/27

(57) ABSTRACT

A method of analyzing a blended airfoil that includes generating a plurality of simulated blended airfoil designs each including one of a plurality of blend geometries, training surrogate models representing the plurality of simulated blended airfoil designs based on natural frequency, modal force, and Goodman scale factors, determining a likelihood of operational failure of each of the plurality of blended airfoil designs in response to one or more vibratory modes, determining which of the plurality of simulated blended airfoil designs violate at least one aeromechanical constraint and generating, a blend design space visualization including a blend design space, where the blend design space includes one or more restricted regions indicating blended airfoil designs where at least one aeromechanical constraint is violates and one or more permitted regions indicating blended airfoil designs where no aeromechanical constraints are violated.

### CROSS REFERENCE TO RELATED APPLICATIONS

This application claims the benefit of U.S. Provisional Application Ser. No. 63/085,430, filed Sep. 30, 2020.

### FEDERALLY SPONSORED RESEARCH STATEMENT

This invention was made with Government support under Contract No. FA865015D2501 awarded by the Department of the Air Force. The Government has certain rights in the invention.

### TECHNICAL FIELD

The present specification generally relates to analysis of airfoil design, including blended airfoils, and more specifically, to probabilistic methods of analyzing and modifying airfoil design.

### BACKGROUND

Current methods of assessing airfoil high cycle fatigue and airfoil blend limits are often overly conservative or overly permissive, causing unnecessary design constraints in some cases and unacceptable field failure rates in other cases. Accordingly, improved methods for analyzing airfoil blend limits and airfoil high cycle fatigue are desired to maximize design and repair flexibility while maintaining high levels of airfoil integrity.

### SUMMARY

In one embodiment, a method of generating a blend design space visualization for use in blending a damaged airfoil includes: generating, using a computing system, a plurality of simulated blended airfoil designs, each including one of a plurality of blend geometries; generating, using the computing system, training data regarding a natural frequency, a modal force, and a Goodman scale factor of the plurality of simulated blended airfoil designs; training, using the computing system, surrogate models representing a blend design space based on the training data; determining, using the computing system, a likelihood of operational failure throughout the blend design space in response to one or more vibratory modes using the surrogate models; determining, using the computing system, one or more regions of the blend design space that violate at least one aeromechanical constraint; generating, using the computing system, a blend design space visualization of the blend design space; and providing, by the computing system, the blend design space visualization to an external system for use in blending a damaged airfoil to form a blended airfoil.

In another embodiment, a method of generating a probabilistic distribution of a likelihood of high cycle fatigue failure for use in manufacturing an airfoil includes generating, using a computing system, a plurality of simulated airfoil designs, each including one of a plurality of airfoil geometries; generating, using the computing system, training data regarding a natural frequency, a modal force, and a Goodman scale factor of the plurality of simulated airfoil designs; training, using the computing system, surrogate models representing an airfoil design space based on the training data; generating, using the computing system, a probabilistic distribution of an airfoil vibratory response of the airfoil design space using the surrogate models; generating, using the computing system, a probabilistic distribution of a high cycle fatigue capability of a material of the airfoil; comparing, using the computing system, the probabilistic distribution of the airfoil vibratory response and the probabilistic distribution of the high cycle fatigue capability of the material to generate a probabilistic distribution of a likelihood of high cycle fatigue failure of the airfoil design space in response to one or more vibratory modes; and providing, by the computing system, data corresponding to the likelihood of high cycle fatigue failure to an external device for the use in manufacturing the airfoil.

In yet another embodiment, a method of determining a likelihood of operational failure for use in airfoil processing includes generating, using a computing system, a plurality of simulated airfoil designs, each including one of a plurality of airfoil geometries; generating, using the computing system, training data regarding a natural frequency, a modal force, and a Goodman scale factor of the plurality of simulated airfoil designs; training, using the computing system, surrogate models representing the plurality of simulated airfoil designs based on the training data; determining, using the computing system, a likelihood of operational failure of each of the plurality of simulated airfoil designs in response to one or more vibratory modes; and providing, by the computing system, data corresponding to the likelihood of operational failure to an external device for the use in airfoil processing.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter described herein. The following detailed description of the illustrative embodiments can be understood when read in conjunction with the following drawings in which:

FIG. 1A schematically depicts an airfoil comprising a damaged region before blending, according to one or more embodiments shown and described herein;

FIG. 1B schematically depicts the airfoil of FIG. 1B after undergoing a blending process, according to one or more embodiments shown and described herein;

FIG. 2 is a flow chart showing a method of analyzing and visualizing airfoil blend limits, according to one or more embodiments shown and described herein;

FIG. 3A depicts a single mode blend design space visualization, according to one or more embodiments shown and described herein;

FIG. 3B depicts a multi-mode blend design space visualization, according to one or more embodiments shown and described herein;

FIG. 3C depicts a blend design space visualization that includes blend parameter constraints, according to one or more embodiments shown and described herein;

FIG. 4 is a flow chart showing a method of analyzing and visualizing airfoil blend limits, according to one or more embodiments shown and described herein;

FIG. 5 is a flow chart showing a probabilistic method of analyzing high cycle fatigue on airfoils, according to one or more embodiments shown and described herein;

FIG. 6 graphically depicts a histogram of airfoil vibratory response as a percentage of material capability along with a cumulative probability density function of the vibratory response, according to one or more embodiments shown and described herein;

FIG. 7 graphically depicts the vibratory response distribution of the airfoil as a function of the −3σ material capability of the airfoil, according to one or more embodiments shown and described herein;

FIG. 8 schematically depicts a variance analysis table for determining which geometric parameters of an airfoil drives variation in airfoil vibratory response for each vibration mode, according to one or more embodiments shown and described herein;

FIG. 9 graphically depicts an endurance limit average determined using an uncalibrated, pre-test model and a calibrated, post-test model calibrated using Bayesian probabilistic tuning, according to one or more embodiments shown and described herein;

FIG. 10 depicts a probabilistic blend design space visualization, according to one or more embodiments shown and described herein; and

FIG. 11 schematically depicts a computing system for performing airfoil blend limit analysis and probabilistic airfoil high cycle fatigue analysis, according to one or more embodiments shown and described herein.

### DETAILED DESCRIPTION

Damage to airfoils during regular jet engine operation is common. With integrally bladed rotors (e.g., blisks) it is expensive to discard an entire rotor due to airfoil damage. Instead, airfoils are often repaired by blending out the damage. However, blending changes the vibrational characteristics of the airfoil and may increase the high cycle fatigue risk associated with the airfoil. Thus, limits are often placed on the region of the airfoil that can be blend repaired. These blend limits are typically based on legacy engine values rather than high cycle fatigue calculations and therefore are often too conservative (in which case the blend limits are very restrictive) or not conservative enough in which case the likelihood of failure of the blended airfoil increases.

In addition, airfoil vibratory responses are subject to variation in forcing (from systemic geometrical parameters such as tip clearance, axial gap, as well as airfoil geometry variation (driven by manufacturing). Thus, the sensitivity of airfoil response may vary and may be vibratory mode-specific. Current high cycle fatigue assessment techniques rely on a deterministic design process that assesses only the nominal design and assigns a blanket design limit to account for these variations. However, these deterministic design limits can end up being too conservative for vibratory modes where less high cycle fatigue variation is observed and non-conservative in extreme cases where geometry variation can drive too much scatter in high cycle fatigue response. The former leads to overly constrained design requirements, which may be hard to meet or may lead to a sub-optimal aerodynamic design in order to meet the conservative aeromechanical requirements. The latter may lead to a risky design and unacceptable field failure rates. Accordingly, improved methods for analyzing airfoil blend limits and airfoil high cycle fatigue are desired to maximize design and repair flexibility while maintaining high levels of airfoil integrity.

Embodiments described herein are directed to methods of analyzing and visualizing airfoil blend limits as dictated by aeromechanical requirements and methods for probabilistic high cycle fatigue assessment on turbomachinery airfoils accounting for variation in airfoil geometry, systemic geometry, material strength, analysis methods and damping. Methods of analyzing high cycle fatigue on turbomachinery airfoils of the embodiments described herein use probabilistic techniques to analyze high cycle fatigue using a single degree of freedom (SDOF) technique with a Monte Carlo simulation to generate percent of endurance limit (% EL) distributions for every vibratory mode of interest and use the simulation to generate an airfoil high cycle fatigue model. After running this Monte Carlo simulation, the effect of one or more material property variations are used to provide a true probability distribution of high cycle fatigue failure. This airfoil high cycle fatigue model may be used to determine which of the geometric features of the airfoil and the surrounding components of the jet engine are driving variations in vibratory response. In some embodiments, a Bayesian calibration framework (e.g., Bayesian probabilistic tuning) can be used to tune certain parameters of the model in order to better represent operational conditions. This tuned model can then be used to make fleet level predictions of failure probabilities.

In addition, to analyze airfoil blend limits, surrogate models are generated to predict the natural frequency and vibratory response of a blended airfoil based on one or more blend parameters, such as depth into the airfoil, radial location on the airfoil (i.e., location between the tip end and the hub end of the airfoil), and aspect ratio. As used herein, “surrogate model” refers to a model of a model and has been used in this document to capture other similar terms used in literature such as metamodels, response surface models or emulators. These surrogate models are then used to generate these outputs (e.g., natural frequency and vibratory response) over the entire blend design space. As used herein “blend design space” refers to the ranges of physical parameters of the airfoil that may be modified to blend out airfoil damage. Using the outputs of the surrogate models, a blend design space visualization may be generated that includes restricted regions of the blend design space and permitted regions of the blend design space, where the restricted regions are regions of the blend design space which violate one or more aeromechanical constraints and the permitted regions are regions of the blend design space which do not violate one or more aeromechanical constraints.

Thus, the permitted regions represent viable parameter alterations that may be performed to blend an airfoil during a maintenance and repair operation. In other words, the permitted regions depict the viable design space. In embodiments, the restricted regions are represented by shading in the blend design space visualization and the permitted regions are unshaded in the blend design space visualization. The blend design space visualization enables a user to interactively update the constraints or assumptions on design variables and evaluate its effects on the allowable blend design space. The blend design space visualization can also be expanded to a probabilistic chart accounting for variation in airfoil geometry, aerodynamic forcing, damping, mistuning amplification and material property variation. These can be used for more accurate reliability assessments and digital twin type applications. Various embodiments of analyzing airfoils are described in more detail herein. Whenever possible, the same reference numerals will be used throughout the drawings to refer to the same or like parts.

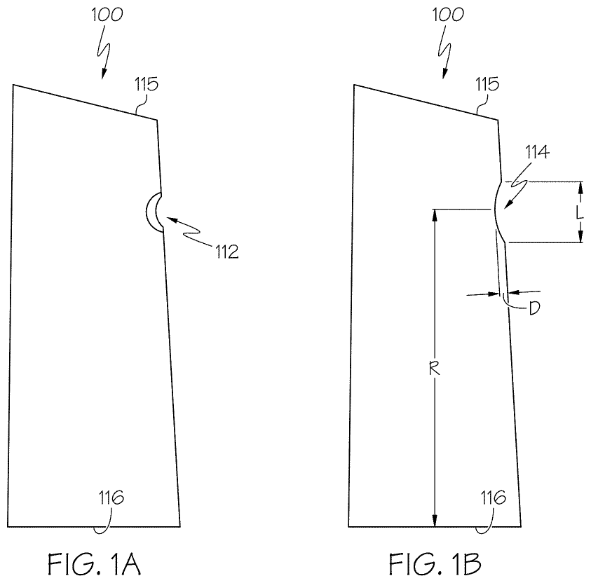

Referring now to FIGS. 1A and 1B, an airfoil 100 with damage before blending (FIG. 1A) and after blending (FIG. 1B) is depicted. As shown in FIGS. 1A and 1B, before blending, the airfoil 100 comprises a damaged region 112 and after blending, the airfoil 100 comprises a blended region 114. The blending process smooths out the damaged region 112 to form the blended region 114, thereby minimizing the likelihood of operational failure and breakdown of the airfoil 100. The airfoil 100 comprises a tip end 115 opposite a hub end 116, which are separated in a radial direction. As shown in FIG. 1B, the blended region 114 is positioned at a radial location R between the tip end 115 and the hub end 116. The blended region 114 extends a depth D into the airfoil 100, and the blended region 114 comprises a length L along the radial direction between the tip end 115 and the hub end 116. Blending may occur at different radial locations R along the airfoil 100 and may extend different depths D into the airfoil 100 and may alter one or more geometric parameters of the airfoil 100, such as local thickness, local width, and local radius.

The geometric parameters of the blended region 114 may be modified within a blend design space, which are the ranges of physical parameters of the airfoil 100 (i.e., blend geometries) that may be modified to blend out airfoil damage. In some embodiments, the blend design space may include at least two blend parameters. For example, a first blend parameter may include the radial location R of the blended region 114 and a second blend parameter may include the depth D of the blended region 114. Using the methods described herein, the limits of the blend design space may be determined to maximize the potential alterations that may be performed during a blend and maximize performance of the airfoil 100 after blending. In particular, changes in physical dimensions of the airfoil 100 during blending alter the natural frequency and vibratory response of the airfoil 100 and the methods herein provide an efficient, cost effective way to determine whether changes in vibratory response and natural frequency induced by dimensional changes of a particular airfoil blend are operationally permissible.

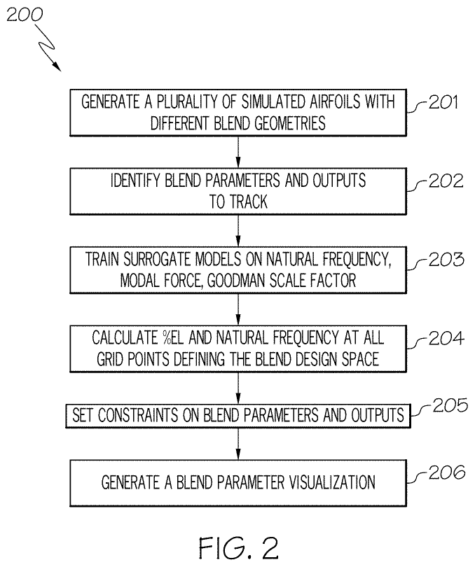

Referring now to FIG. 2, a flowchart 200 is depicted showing an embodiment of the method of analyzing and visualizing airfoil blend limits. At step 201, the method first includes generating a plurality of simulated airfoil designs (e.g., hundreds of simulations or more) having a variety of different blend geometries. The plurality of simulated airfoil designs represent as-manufactured airfoils. Next, at step 202, the method includes identifying blend parameters and outputs to track. Example blend parameters include the radial location R of the blended region 114, the maximum depth D of the blended region 114, the length L of the blended region 114, and the aspect ratio L/D of the blended region 114 (FIG. 1A). It should be understood that this parameterization is specific to elliptical blends. Other types of blends such as a J-cut, or a tip crop can be parameterized using a different set of parameters and blend design space visualizations may also be generated for these different sets of parameters. Next, at step 203, the simulations of airfoil designs are used to train surrogate models with respect to three aeromechanical quantities (natural frequency (f), modal force (F_{modal}), and Goodman scale factor (GSF)) as a function of blend parameters. Without intending to be limited by theory, the Goodman scale factor (GSF) is a scalar number by which, when the modal stresses are scaled, puts at least one location of the structure (e.g., an airfoil) on the Goodman curve. In other words this is the maximum number the modal stresses can be multiplied with, without exceeding material high cycle fatigue capability. The surrogate models are trained on these quantities by designing and analyzing a plurality of blended airfoils, for example, 100 or more blended airfoils, using an automated, regression process, such as neural net modeling.

Next, at step 204 of the method, the surrogate models are used to calculate the outputs as a function of blend parameters. The surrogate models calculate the natural frequency, modal force and Goodman scale factors based on the blend parameters to determine the outputs, which include change in natural frequency from original airfoil design (AO, endurance limit (% EL), and change in endurance limit from original airfoil design (Δ % EL). Using the outputs calculated by the surrogate models, the aeromechanical risk (i.e., the likelihood of operational failure) of any blended airfoil (i.e., throughout the blend design space) in terms of natural frequencies or vibratory response (represented by percent of endurance limits) can be calculated using the single degree of freedom (SDOF) equation. Additional design variables that may be input into the SDOF equation include damping (Q), mistuning amplification (kᵥ), the non-uniform vane spacing factor (Kₙᵤᵥₛ), and the aero-scaling factor to scale from modeled aero conditions to the condition at which the mode crossing is expected (Pₛ). In some embodiments, these additional design variables may be generated as statistical distributions. Without intending to be limited by theory, using surrogate models to calculate the aeromechanical design risk throughout the blend design space is more efficient than performing an individual, high fidelity simulations on each of the plurality of simulated airfoil designs.

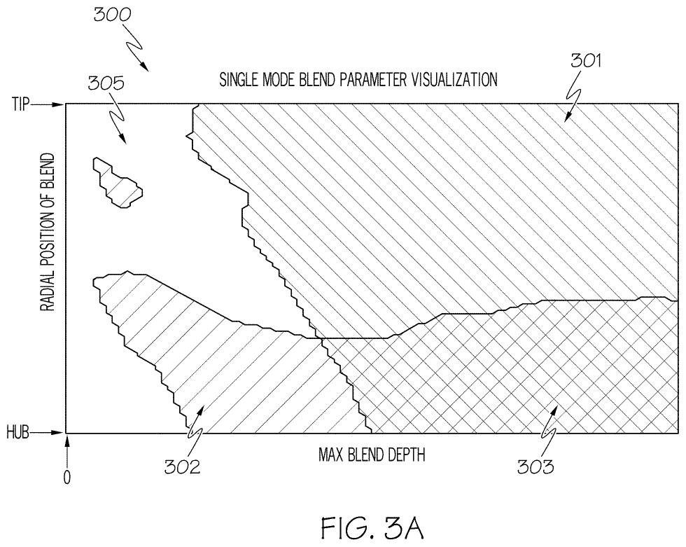

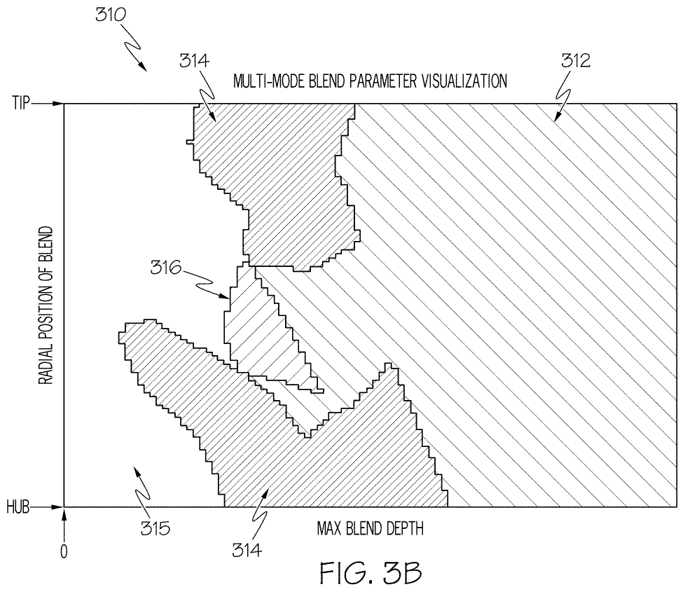

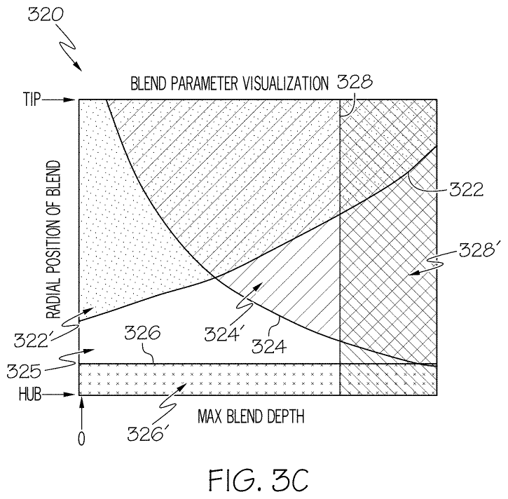

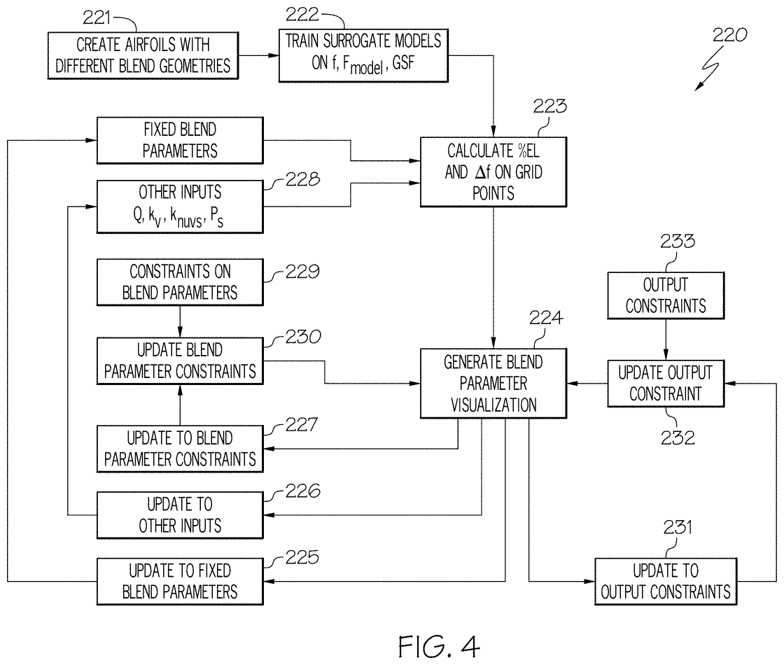

At step 205, the method includes setting constraints on the blend parameters and the outputs. Example blend parameter constraints include a depth constraint D<Dₘₐₓ, a radial location constraint H>Hₘᵢₙ, and an aspect ratio constraint. Example output constraints include % EL<% ELₘₐₓ, Δ % EL<Δ % ELₘₐₓ, and Δf<Δfₘₐₓ. The constraints are set based on the calculated aeromechanical risk, which may be determined by accessing a database that stores prior fleet information. Finally, at step 206, the method includes generating a blend design space visualization which visualizes the constraints of the blend design space. Indeed, the blend design space visualization comprises data corresponding to the likelihood of operational failure of throughout the blend design space, which represents a plurality of blended airfoil designs. The method of analyzing and visualizing airfoil blend limits may be performed at a number of vibratory modes. This allows the model to be exercised over the entire blend design space and facilitates the formation of a blend design space visualization (i.e., design space chart), examples of which are shown in FIGS. 3A-3C, which visualize the resultant design region where one or more airfoil blend limits are violated. Moreover, the airfoil blend limits and the blend design space visualization may be continuously updated, based on a feedback loop of updated inputs and updated constraints, as described in more detail below with respect to FIG. 4.

While not intending to be limited by theory, the method of analyzing and visualizing airfoil blend limits shown by flowchart 200 of FIG. 2 eliminates the need for separate, case specific aeromechanical assessments (i.e., MRB assessments). Instead, a proposed blend that is not initially conforming can be located on the blend design space visualization to assess the acceptability of the proposed blend. The method of analyzing and visualizing airfoil blend limits described herein generates aeromechanical blend limits that are grounded in physics, in contrast to previous, legacy based techniques. In addition, the blend limits determined with the techniques described herein are potentially less restrictive than previous techniques, which may increase the situations in which a cheaper airfoil blend repair is implemented instead of a more expensive replacement.

Referring now to FIGS. 3A-3C, example blend design space visualizations 300, 310, 320 are depicted. FIG. 3A depicts a single mode blend design space visualization 300, FIG. 3B depicts a multi-mode blend design space visualization 310, and FIG. 3C depicts a blend design space visualization 320 that includes blend parameter constraints. The blend design space visualizations 300, 310, 320 are interactive charts that visualize the blend design space. The blend design space visualizations 300, 310, 320 includes shaded regions (regions 301, 302, and 303 in FIG. 3A, regions 312, 314, and 316 in FIG. 3B, and regions 322′, 324′, 326′, and 328′ in FIG. 3C) indicating that at least one aeromechanical constraint is violated by the blend depth and radial location of a blended region having the geometric parameters in the shaded regions. That is, the shaded regions represent restricted regions of the blend design space. Other design variables (damping, mistuning amplification, blend aspect ratio) can be updated interactively along with the constraints on outputs to enable an engineer to check sensitivities and exercise engineering judgement while setting blend limits. Design spaces for multiple vibratory modes can be combined to generate a single chart which shows the blend region which would be allowable for all vibratory modes. Moreover, the methods of analyzing airfoil blend limit by visualizing airfoil blend design space are primarily focused on two aeromechanical requirements—change in natural frequency and change in vibratory response. In some cases the absolute vibratory response may also be considered.

In the single mode blend design space visualization 300 of FIG. 3A, shaded region 301 indicates blend depth and radial position combinations at which a first aeromechanical constraint is violated, shaded region 302 indicates blend depth and radial position combinations at which a second aeromechanical constraint is violated, and shaded region 303 indicates blend depth and radial position combinations at which both the first and second aeromechanical constraints are violated. These shaded regions represent restricted regions of the blend design space. Moreover, unshaded region 305 indicates available blend space, that is, blend depth and radial position combinations at which no aeromechanical constraints are violated. These unshaded region represents a permitted region of the blend design space. In the multi-mode blend design space visualization 310 of FIG. 3B, shaded region 312 indicates blend depth and radial position combinations at which at least one aeromechanical constraint is violated for a first vibratory mode, shaded region 312 indicates blend depth and radial position combinations at which at least one aeromechanical constraint is violated for a second vibratory mode, and shaded region 316 indicates blend depth and radial position combinations at which at least one aeromechanical constraint is violated for a third vibratory mode. Moreover, unshaded region 315 indicates available blend space, that is, blend depth and radial position combinations at which no aeromechanical constraints are violated for any vibratory modes. In operation, a damaged airfoil may be blended with any of the blend parameters within the available blend space to repair the damaged airfoil (i.e., blending the damaged airfoil). Moreover, the blend design space visualization may be interactive, allowing a user to individually adjust blend parameters, additional design variables, input constraints, and output constraints.

The blend design space visualization 320 of FIG. 3C shows the available blend space (indicated by unshaded region 325) for an example embodiment that accounts for two aeromechanical constraints and two blend parameter constraints. In particular, in the blend design space visualization 320 of FIG. 3C, shaded region 322′ indicates blend depth and radial position combinations at which a first aeromechanical constraint is violated. The shaded region 322′ comprises the region above line 322 in the blend design space visualization 320. Shaded region 324′ indicates blend depth and radial position combinations at which a second aeromechanical constraint is violated. The shaded region 324′ comprises the region above line 324 in the blend design space visualization 320 and partially overlaps with shaded region 322′. In addition, the blend design space visualization 320 includes shaded regions 326′ and 328′, which each represent a blend parameter constraint. The shaded region 326′ is bounded by line 326 and represents a depth constraint and the shaded region 328′ is bounded by line 328 and represents a radial location constraint. Moreover, unshaded region 325 indicates available blend space, that is, blend depth and radial position combinations at which no aeromechanical constraints are violated. In operation, a damaged airfoil may be blended with any of the blend parameters within the available blend space to repair the damaged airfoil (i.e., blending the damaged airfoil). Moreover, the blend design space visualization may be interactive, allowing a user to individually adjust blend parameters, additional design variables, input constraints, and output constraints.

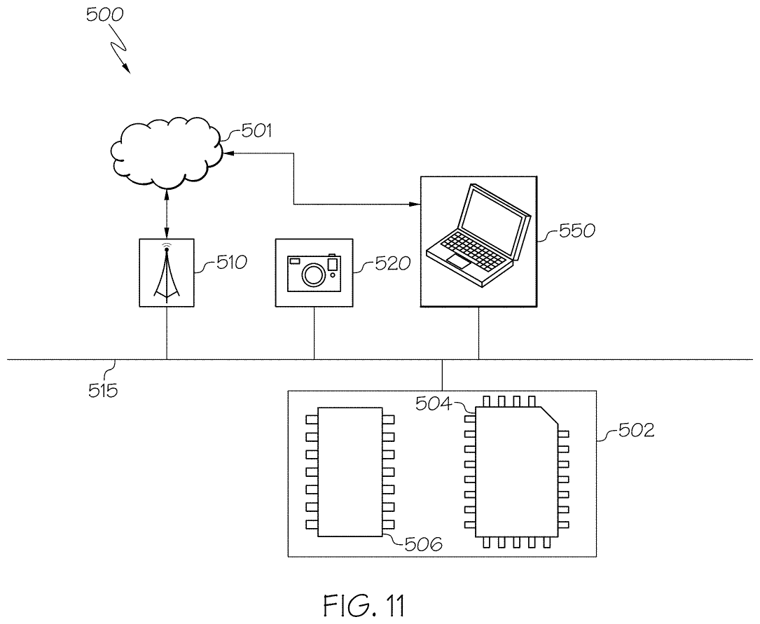

Referring now to FIG. 4, a flowchart 220 showing an embodiment of a method of analyzing and visualizing airfoil blend limits, similar to the method shown by flowchart 200 of FIG. 2, in which the steps of calculating the EL % and generating the blend design space visualization may be continuously updated based on updated inputs and updated constraints. At box 221, the method includes creating a plurality of simulated airfoil designs having a variety of different blend geometries. Next, at box 222, the simulations of airfoil designs are used to train surrogate models with respect to three aeromechanical quantities (natural frequency (f), modal force (F_{modal}), and Goodman scale factor (GSF)). Next, at box 223, the method includes using the surrogate models to calculate a change in natural frequency from original airfoil design (AO and an endurance limit (% EL). As shown in FIG. 4, calculating Δf and % EL at box 223 uses surrogate model data (box 222), fixed blend parameters (box 234) and other inputs, such as damping (Q), mistuning amplification (kᵥ), the non-uniform vane spacing factor (Kₙᵤᵥₛ), and the aero-scaling factor to scale from aero conditions to crossing (Pₛ), (box 228). These other inputs may be stored in one or more memory modules 506 of the computer device 502 (FIG. 11). In some embodiments, these other inputs may be generated as statistical distributions. Indeed, the endurance limit (% EL) may be determined by performing a Monte Carlo analysis using the SDOF equation:

$$\% EL = \frac{{F}_{modal} Q}{{( 2 π f )}^{2}} ( {P}_{s} {k}_{v} {k}_{nuvs} ) \frac{1}{GSF} .$$

While not intending to be limited by theory, the endurance limit (% EL) represents a vibratory response as a percentage of material capability. Moreover, the calculation of the endurance limit using the SDOF equation may also account for uncertainties from manufacturing geometry variation.

Next, at box 224, the method includes generating a blend design space visualization, such as the blend design space visualizations 300, 310, 320 depicted in FIGS. 3A-3C. The blend design space visualizations are generated based on the outputs (e.g., Δf and % EL) calculated at box 223, blend parameter constraints (boxes 229 and 230), and output constraints (boxes 232 and 233). Constraints are set based on the calculated aeromechanical risk. Example blend parameter constraints include a depth constraint D<Dₘₐₓ, a radial location constraint H>Hₘᵢₙ, and an aspect ratio constraint. Example output constraints include % EL<% ELₘₐₓ, Δ % EL<Δ % ELₘₐₓ, and Δf<Δfₘₐₓ.

Once a blend design space visualization is generated, the blend parameters, the blend parameter constraints, the other inputs, the outputs, and the output constraints may be continuously or intermittently updated. These updates are part of a feedback loop that provides updated information to modify the calculation of Δf and % EL at box 223 and the generation of the blend design space visualization at box 224. In particular, updates to fixed blend parameters are performed at box 225, updates to damping (Q), mistuning amplification (kᵥ), the non-uniform vane spacing factor (Kₙᵤᵥₛ), and the aero-scaling factor to scale from aero conditions to crossing (Pₛ) are performed at box 226, updates to blend parameter constraints are performed at box 227, and updates to input constraints are performed at box 231. As shown in FIG. 4, the blend design space visualization may be continuously updated with new data to provide real time blend design space visualizations during the process of designing an airfoil blend and performing an airfoil blend.

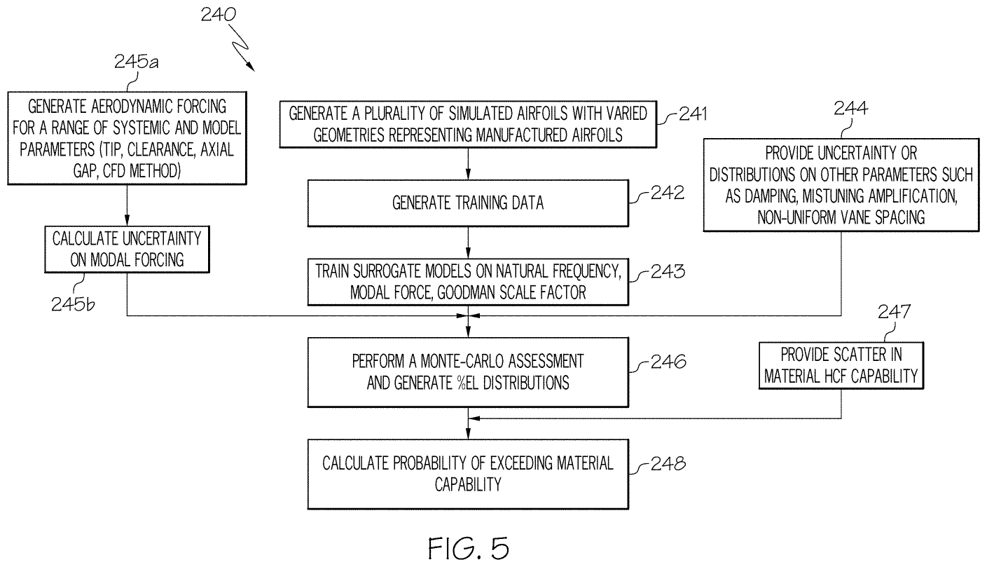

Referring now to FIG. 5, a flow chart 240 depicts a probabilistic method of analyzing high cycle fatigue on airfoils. At step 241, the method first includes creating a plurality of simulated airfoils with varied geometries representing a variety of as-manufactured airfoils (i.e., airfoils having a variety of dimensional combinations). As used herein, “airfoil design space” refers to the variety of dimensional combinations of the plurality of simulated airfoils. At step 242, the method next includes generating training data regarding three scalar parameters—natural frequency, modal force, and Goodman scale factor from the plurality of simulated airfoils. As used herein, “training data” refers to one or more datasets that are used to develop a machine learning model, from which the model, such as a neural net model, creates and relines its rules and recognizes patterns (e.g., during a training process using the training data). In the methods herein, the training data comprises one or more datasets regarding the three scalar parameters (natural frequency, modal force, and Goodman scale factor) that may be generated for each vibration mode of interest, for example, by simulation using high fidelity aerodynamic and mechanical design tools. For example, at both steps 241 and 242, the simulated airfoil designs and training data may be generated using Monte Carlo simulations. Next, at step 243, surrogate models of the plurality of simulated airfoils may be trained based on three scalar parameters—natural frequency, modal force, and Goodman scale factor. Once the surrogate models are trained, endurance limit distributions may be generated at step 246 using a Monte Carlo analysis. However, as shown in steps 244, 245a, and 245b, additional inputs may be also be included to generate the endurance limit distributions at step 246.

For example, at step 244, additional inputs such as damping (Q), mistuning amplification (kᵥ), the non-uniform vane spacing factor (Kₙᵤᵥₛ), and the aero-scaling factor (Pₛ) are provided. In some embodiments, damping may be obtained from legacy engine test experience data or rig testing data, which may be stored in a database. Mistuning amplification factor distributions can be obtained using a mistuning model, such as the FMM model described in Feiner, D. M., and Griffin, G. H., “A Fundamental Model of Mistuning for a Single Family of Modes,” Journal of Turbomachinery, Vol. 124, No. 4, 2002, pp. 597-605, the SNM model described in Yang, M. T., and Griffin, J. H., “A Reduced-Order Model of Mistuning Using a Subset of Nominal System Modes,” Journal of Engineering for Gas Turbines and Power, Vol. 123, No. 4, 2001, pp. 893-900, and the CMM model, described in Lim, S., Bladh, R., Castanier, M. P., and Pierre, C., “A Compact, Generalized Component Mode Mistuning Representation for Modeling Bladed Disk Vibrations,” Proceedings of the 44th AIAA/ASME/ASCE/AMA Structures, Structural Dynamics and Material Conference, Vol. 2, AIAA, Reston, Va., 2003, pp. 1359-1380. Moreover, both the non-uniform vane spacing factor (Kₙᵤᵥₛ), and the aero-scaling factor (Pₛ) may be estimated using a combination of models, empirical relationships and legacy experience.

Furthermore, at step 245a, aerodynamic forcing may be generated for a range of systemic and model parameters, such as the geometric features of the airfoil and the surrounding components of the jet engine which drive variations in vibratory response. Example parameters include tip clearance, axial gap, and measurements based on computational fluid dynamics (CFD). These parameters may be used at step 245b to calculate the uncertainty on modal forcing, data which is used when generating endurance limit distributions at step 246. Indeed, the endurance limit (% EL) may be calculated by performing a Monte Carlo analysis using the SDOF equation:

$$\% EL = \frac{{F}_{modal} Q}{{( 2 π f )}^{2}} ( {P}_{s} {k}_{v} {k}_{nuvs} ) \frac{1}{GSF} .$$

While not intending to be limited by theory, the endurance limit (% EL) represents a vibratory response as a percentage of material capability. Moreover, the calculation of the endurance limit using the SDOF equation may also account for uncertainties from manufacturing geometry variation.

Once the endurance limit distributions are generated, the distribution of material high cycle fatigue may be provided at step 247, for example, by accessing a database. Next, at step 248, the probability of exceeding material capabilities of the simulated airfoils may be determined by comparing the endurance limit distribution and the distribution of material high cycle fatigue to generate a probability distribution of high cycle fatigue failure (i.e., operational failure). The endurance limit distributions may be used to determine the likelihood of high cycle fatigue failure throughout the airfoil design space and determine how different material property variations effect vibratory stress. This probabilistic assessment can solve the issues of over and under constraint of design requirements that may arise when using deterministic design limits, by performing the assessment on a vibratory mode-specific basis and calculating a probability of failure for every vibratory mode of interest.

Designing airfoils based on a probabilistic assessment facilitates the manufacture of better performing airfoils, while requiring fewer design iterations to form an early understanding of the effects of design decisions on component failure rate. Furthermore, the probabilistic method of analyzing high cycle fatigue on airfoils described herein is based on the SDOF forced response model which captures of effects of airfoil and systemic geometry variation through only three scalar parameters—natural frequency, modal force, and Goodman scale factor. This allows for establishing simplified workflows well-suited for use in an industrial setting under time-constrained design cycles and may reduce design cycle time due to less redesign driven by less restrictive requirements. The probabilistic techniques lead to fewer design practice deviations than previous deterministic techniques. Design practice deviations typically require an individual analysis, reducing design and manufacturing efficiency.

The probabilistic techniques also reduce the number of separate case specific aeromechanical assessments (i.e., MRB assessments). Moreover, the analysis of variances in airfoil response facilitated by the methods described herein increase understanding of the key geometric parameters driving variation in response which may improve airfoil design. In other words, airfoil high cycle fatigue models may be used to determine which the geometric features of the airfoil and the surrounding components of the jet engine which are driving variations in vibratory response, forming a better understanding of what geometric features drive failure rate and a more precise understanding of the geometric tolerances, which may lead to less restrictive aeromechanical requirements and more optimally performing airfoils. Indeed, the probabilistic method of analyzing high cycle fatigue on airfoils may further include to manufacturing an airfoil comprising an airfoil geometry having a likelihood of high cycle fatigue failure below a failure threshold, where the failure threshold is based on a threshold endurance limit of the airfoil geometry.

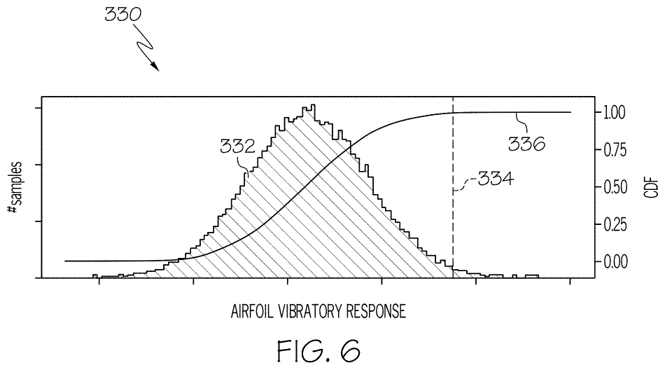

Referring now to FIG. 6, the probability of airfoil response to vibratory stress exceeding material capabilities of the airfoil is graphically depicted in graph 330. In particular, graph 330 is a histogram of airfoil vibratory response as a percentage of material capability along with a cumulative probability density function of the vibratory response. The distribution of airfoil vibratory response as a percentage of the material's (−3σ) endurance limit is depicted in graph 330. From this histogram, the probability of exceeding a certain percentage endurance limit can be calculated. This limit could be set at the currently used deterministic limit to calculate the likelihood of the response exceeding current deterministic design limits. Graph 330 includes region 332 which represents the probabilistic spread of the airfoil vibratory response of the airfoil design space. Graph 330 includes line 334, which is the threshold endurance limit, that is, the endurance limit at which fatigue failure occurs. In FIG. 6, the threshold endurance limit is a deterministic design limit. Moreover, line 336 represents the cumulative probability of failure due to vibratory response as a function of minimum endurance limit increases.

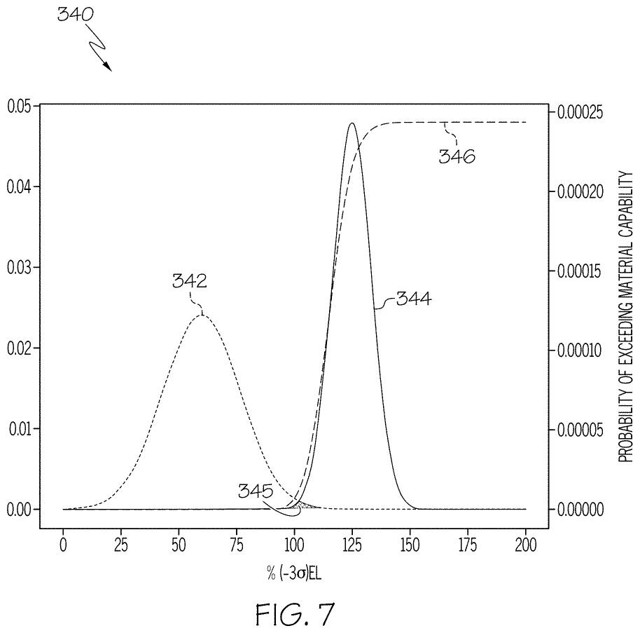

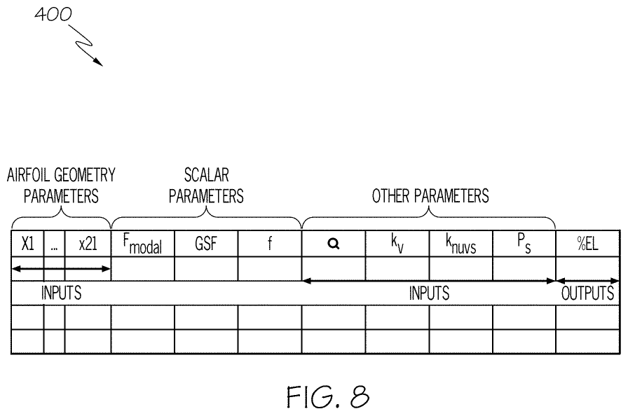

Referring now to FIG. 7, graph 340 depicts the vibratory response distribution of airfoil design as a function of the −3σ material capability. Assuming the material capability to be normally distributed, the material capability is expected to be greater than the −3σ material capability 99.87% of the time. The material high cycle fatigue capability probability distribution is also plotted in graph 340. In graph 340, the left Y axis is a normalized count of the probability density function and the right Y axis is the probability of exceeding material capability. In graph 340, line 342 represents vibratory response distribution, that is, the airfoil vibratory response of the airfoil design space represented as a percentage of endurance limit. In addition, line 344 represents the material property distribution, that is, the probability distribution of the airfoil material's high cycle fatigue capability. This information regarding the material of the airfoil may be stored in a database. The distributions represented by line 342 and line 344 can be constructed from material fatigue test databases which record variation in material capability. In graph 340, the quantity of interest is the probability of the airfoil vibratory response exceeding the material capability, which is represented by overlap region 345, that is, the region in which the vibratory response exceeds the material capability. The probability of the airfoil vibratory response exceeding the material capability may be used as a metric to accept or reject an airfoil design. By using probabilistic techniques, as shown in FIG. 7, the airfoil design space may be expanded beyond the deterministic limit shown in FIG. 6. That is, the threshold endurance limit may be lower that the deterministic limit of FIG. 6, broadening the available airfoil design space. Without intending to be limited by theory, the probability of the airfoil vibratory response exceeding the material capability is calculated using the following equation: ∫_{-∞}^{∞}∫_{-∞}^{x}p(y)dy p(x)dx where x is the vibratory response distribution and y is the material response distribution. Moreover, line 346 represents the cumulative probability of a vibratory response exceeding the material capability. That is, line 346 shows the cumulative probability of failure due to vibratory response as the vibratory response increases (measured as a percent of the threshold endurance limit).

To support this analysis, a variance analysis may be performed to determine the relative impact of each of a plurality of geometric parameters of an airfoil design on the airfoil's response to vibratory stress. Referring now to FIG. 8, a variance analysis table 400 is shown, which may be used for this variance analysis. The variance analysis table 400 is used for determining which geometric parameters of an airfoil drives variation in airfoil vibratory response for each vibration mode. Inputs to the variance analysis table 400 includes geometry parameters of the one or more simulated airfoils, scalar parameters generated from the training data, that is, natural frequency (f), modal force (F_{modal}), and Goodman scale factor (GSF). Other parameters that may also be used as inputs into the variance analysis table 400 include damping (Q), mistuning amplification (kᵥ), the non-uniform vane spacing factor (Kₙᵤᵥₛ), and the aero-scaling factor to scale from aero conditions to crossing (Pₛ). Based on these inputs, the variance analysis table 400 may measure the endurance limit (% EL) of a variety of different airfoil designs. Indeed, the endurance limit (% EL) may be calculated by performing a Monte Carlo analysis using the SDOF equation:

$$\% EL = \frac{{F}_{modal} Q}{{( 2 π f )}^{2}} ( {P}_{s} {k}_{v} {k}_{nuvs} ) \frac{1}{GSF} .$$

While not intending to be limited by theory, the endurance limit (% EL) represents a vibratory response as a percentage of material capability. Moreover, the calculation of the endurance limit using the SDOF equation may also account for uncertainties from manufacturing geometry variation.

The variance analysis table 400 can be used to provide blisk-specific reliability estimates when the measured airfoil geometries of the blisk are fed in. Such blisk-specific estimates can be rolled up across the fleet to obtain a fleet-level (e.g., global) reliability estimate for the part. This analysis may be used to determine the relative impact of high cycle fatigue response different design variables. Indeed, certain design parameters may have a disproportionate impact on high cycle fatigue response. Using the methods described herein, these disproportionately impactful geometric design parameters of the airfoil may be identified, facilitating improved airfoil design. This analysis may also be used to determine the relative impact of high cycle fatigue response different systemic variables, such as axial gap, tip clearances, assembly tolerances, and the like. The effects systemic variables on aerodynamic forcing is captured through modal forces. In addition, this analysis may be used to determine the relative input of aerodynamic modeling practices, such as the effect of boundary conditions, airfoil fillets, and vane buttons. The uncertainty on modal forces can be propagated to the calculated response through the Monte-Carlo analysis. Similarly, other sources of uncertainty such as in non-uniform vane spacing where Kₙᵤᵥₛ varies with the assumed wake pattern, or the mistuning amplification factor which is a function of the natural frequency distribution of the airfoils on a blisk, can also be propagated through the Monte Carlo analysis.

One issue that is often faced in predicting airfoil vibratory response is a disconnect between pre-test analytical predictions and responses observed in a rig or engine test. Using current techniques, once an airfoil vibratory response is observed the tested part is assumed to be representative of all manufactured parts. However, this may not be accurate. To remedy this potential inaccuracy, in the embodiments described herein, Bayesian probabilistic tuning may be used to help calibrate uncertain parameters in the physics-based model described herein and fills gaps in the physics-based model by providing a discrepancy model (which bridges the gap between observed data and a calibrated model). The Bayesian probabilistic tuning used is the embodiments described herein may be based on the Kennedy O'Hagan formulation, as described in Kennedy, M., and O'Hagan, A., “Bayesian calibration of computer models (with discussion)”. Journal of the Royal Statistical Society (Series B), 68, 2001. Bayesian probabilistic tuning provides the probabilistic airfoil high cycle fatigue model tuned with test data in order to get better fleet level predictions of airfoil high cycle fatigue. These calibrated predictions can be used for more accurate reliability assessments and digital twin type applications. Without intending to be limited by theory, a digital twin is a digital replica of a physical entity. That is, a digital twin is a digital version of a machine (also referred to as an “asset”). Once created, the digital twin can be used to represent the machine in a digital representation of a real world system. The digital twin is created such that it computationally mirrors the behavior of the corresponding machine. Additionally, the digital twin may mirror the state of the machine within a greater system. For example, sensors may be placed on the machine (e.g., an airfoil) to capture real-time (or near real-time) data from the physical object to relay it back to a remote digital twin. The digital twin can then make any changes necessary to maintain its correspondence to the twinned asset, providing operations instruction, diagnostics, insight to unmeasurable internal physical dynamics, insight to efficiencies and reliability.

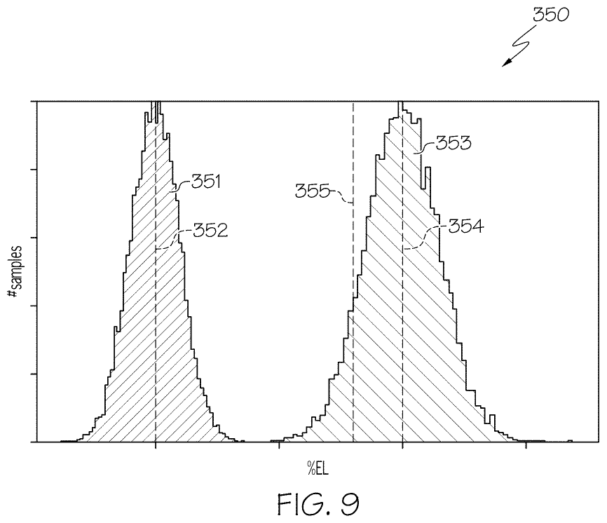

Referring now to FIG. 9, graph 350 depicts a comparison between an uncalibrated, pre-test model and a calibrated, post-test model calibrated using Bayesian probabilistic tuning. In graph 350, section 351 represents the endurance limit spread of a plurality of simulated airfoils that underwent regression analysis using an uncalibrated, pre-test model and section 353 represents the endurance limit spread of the plurality of simulated airfoils of section 351, however, instead of the uncalibrated model to generate the endurance limit spread, in section 353 a model calibrated using Bayesian probabilistic tuning is used to generate the endurance limit spread. For example, Bayesian probabilistic tuning may be used to tune input parameters such as damping (Q), mistuning amplification (kᵥ), the non-uniform vane spacing factor (Kₙᵤᵥₛ), and the aero-scaling factor to scale from aero conditions to crossing (Pₛ).

While not intending to be limited by theory, traditional regression uses the following equation: y(x)±∈(x)=η(x) where y(x) is the observation, ∈(x) is the experimental error, η(x) is the simulator, x is the randomized design parameters, and η is a regression model, such as a Gaussian process model. While still not intending to be limited by theory, Bayesian probabilistic tuning uses the following equation: y(x)±∈(x)=η(x,\hat{θ})+δ(x) where y(x) is the observation, ∈(x) is the experimental error, n(x,\hat{θ}) is the simulator, δ(x) is the discrepancy, x is the randomized design parameters, \hat{θ} represents the calibration parameters, η is a Gaussian process model, which captures the best physics-based prediction, and δ is another Gaussian process model, which described the unmodeled physics by η.

Referring still to FIG. 9, line 352 is the modeled average endurance limit of section 351 and line 354 is the modeled average endurance limit of section 353. In addition, line 355 is a real-world test average of the endurance limit of an as-manufactured airfoil with the properties of the plurality of simulated airfoils. As shown in FIG. 9, the Bayesian probabilistic tuning generates a modeled average endurance limit (shown by line 354) that is much closer to the test average (shown by line 355) than the modeled endurance limit generated using an uncalibrated model (shown by line 352).

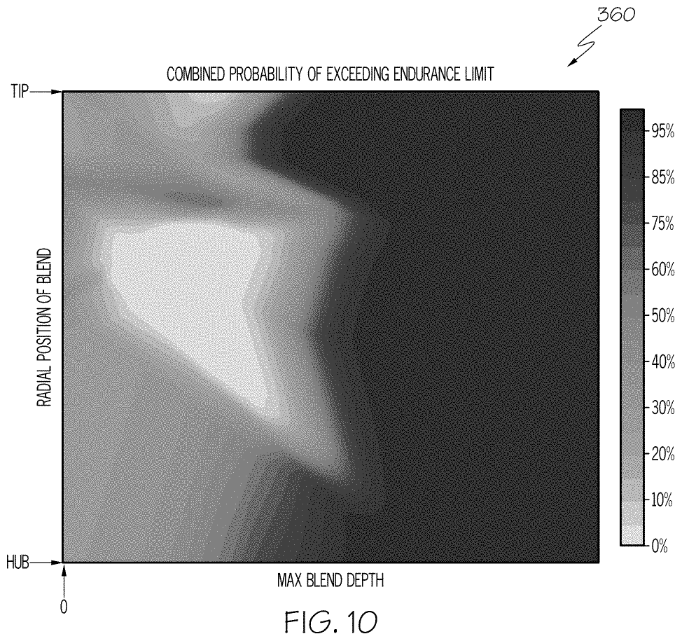

Referring now to FIG. 10, in some embodiments, the probabilistic techniques used to analyze high cycle fatigue on airfoils described above may also be incorporated into the methods of generating blend design space visualizations of blend limits. Indeed, FIG. 10 depicts a probabilistic blend design space visualization 360. Probabilistic blend design space visualizations 360 may consider variations in damping, mistuning amplification factors, airfoil geometry, aerodynamic forcing and material properties. The probabilistic blend design space visualization 360 depicts the probability of exceedance on one or more aeromechanical constraints and the combined probability of reaching the blend limit using a gradient (shown in grayscale in FIG. 10). Indeed, the probabilistic blend design space visualization 360 may comprise a contour plot depicting a probability of at least one aeromechanical constraint violation (i.e., exceedance) at each point in the blend design space. In some embodiments, that probabilistic blend design space visualizations 360 have a grid point analysis functionality, allowing a user see a detailed breakdown, such as a graphical breakdown of the probability of exceeding blend limits on each parameter point on the probabilistic blend design space visualization 360. In some embodiments, variation in material properties can also be considered and a probability of exceeding material high cycle fatigue capability can be computed following the process described above with respect to FIG. 7.

Referring now to FIG. 11, the methods described herein may be implemented on a computing system 500 that includes a network 501 communicatively coupled to a computer device 502 that includes at least a processor 504 and on-transitory, processor-readable storage medium 506 (i.e., one or more memory modules 506) that includes programming instructions stored thereon that are executable by the processor 504 to perform the functions of any of the embodiments described herein. In some embodiments, such as the embodiments of FIGS. 1-4, the computing system 500 may provide data corresponding the blend design space visualization (e.g., blend design space visualizations 300, 310, 320, 360) to an external system 550, such as an electronic control unit for a blending machine for use in processing an airfoil, such as blending a damaged airfoil. In some embodiments, such as the embodiments of FIGS. 5-9, the computing system 500 may provide data corresponding a likelihood of high cycle fatigue failure of one or more simulated airfoil designs to an external system for use in airfoil processing, such as a computing system for designing airfoil or an electronic control unit for one or more airfoil manufacturing machines used to manufacture an airfoil. Furthermore, the computing system 500 may include an imaging device 520 for capturing images of an airfoil, such as a damaged airfoil or a blended airfoil.

Referring still to FIG. 11, any of the components of the computer device 502 may be implemented in a single computer device 502, distributed across multiple computer devices 502, or using cloud computing resources. Some non-limiting examples of computer devices 502 include laptops, desktops, smartphone devices, tablets, PCs, cloud computing platforms, or the like. Various cloud computing platforms are well-known and available under product names including, but not limited to Amazon Web Services, Google Cloud Platform, Microsoft Azure, and IBM Bluemix. Each of the one or more processors 504 of the computer device 502 may be any device capable of executing machine readable instructions. Accordingly, each of the one or more processors 504 may be a controller, an integrated circuit, a microchip, a computer, or any other computing device. The one or more processors 504 are coupled to a communication path 515 that provides signal interconnectivity between various components of the computing system 500. Accordingly, the communication path 515 may communicatively couple any number of processors 504 with one another, and allow the components coupled to the communication path 515 to operate in a distributed computing environment. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 515 may be formed from any medium that is capable of transmitting a signal such as, for example, conductive wires, conductive traces, optical waveguides, or the like. In some embodiments, the communication path 515 may facilitate the transmission of wireless signals, such as WiFi, Bluetooth, and the like. Moreover, the communication path 515 may be formed from a combination of mediums capable of transmitting signals. In one embodiment, the communication path 515 comprises a combination of conductive traces, conductive wires, connectors, and buses that cooperate to permit the transmission of electrical data signals to components such as processors, memories, sensors, input devices, output devices, and communication devices. Accordingly, the communication path 515 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The one or more memory modules 506 of the computer device 502 may comprise RAM, ROM, flash memories, hard drives, or any device capable of storing machine readable instructions such that the machine readable instructions can be accessed by the one or more processors 504. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 506. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Moreover, the machine readable instructions stored on the one or more memory modules 506 may include one or more machine learning models, trained on the historical operations data, to generate the custom probability distributions. Machine learning models may include but are not limited to Neural Networks, Linear Regression, Logistic Regression, Decision Tree, SVM, Naive Bayes, kNN, K-Means, Random Forest, Dimensionality Reduction Algorithms, or Gradient Boosting algorithms, and may employ learning types including but not limited to Supervised Learning, Unsupervised Learning, Reinforcement Learning, Semi-Supervised Learning, Self-Supervised Learning, Multi-Instance Learning, Inductive Learning, Deductive Inference, Transductive Learning, Multi-Task Learning, Active Learning, Online Learning, Transfer Learning, or Ensemble Learning.

Still referring to FIG. 11, in some embodiments, the network 501 may comprise, for example, a personal area network, a local area network, or a wide area network, cellular networks, satellite networks and/or a global positioning system and combinations thereof. Example local area networks may include wired Ethernet and/or wireless technologies such as, for example, wireless fidelity (Wi-Fi). Moreover, example personal area networks may include wireless technologies such as, for example, IrDA, Bluetooth, Wireless USB, Z-Wave, ZigBee, and/or other near field communication protocols, and/or wired computer buses such as, for example, USB and FireWire. Suitable cellular networks include, but are not limited to, technologies such as LTE, WiMAX, UMTS, CDMA, and GSM.

Referring still to FIG. 11, the imaging device 520 of the computing system 500 may comprise any sensor operable to capture image data, such as, without limitation, a charged-coupled device image sensors or complementary metal-oxide-semiconductor sensors capable of detecting optical radiation having wavelengths in the visual spectrum, for example. The imaging device 520 may be configured to detect optical radiation in wavelengths outside of the visual spectrum, such as wavelengths within the infrared spectrum. In some embodiments, two or more imaging devices 520 are provided to generate stereo image data capable of capturing depth information. Moreover, in some embodiments, the imaging device 520 may comprise a camera, which may be any device having an array of sensing devices (e.g., pixels) capable of detecting radiation in an ultraviolet wavelength band, a visible light wavelength band, or an infrared wavelength band.

Still referring to FIG. 11, the computing system 500 comprises network interface hardware 510 for communicatively coupling the computer device 502 to the network 501. The network interface hardware 510 can be communicatively coupled to the communication path 515 and can be any device capable of transmitting and/or receiving data via a network. Accordingly, the network interface hardware 510 can include a communication transceiver for sending and/or receiving any wired or wireless communication. For example, the network interface hardware 510 may include an antenna, a modem, LAN port, Wi-Fi card, WiMax card, mobile communications hardware, near-field communication hardware, satellite communication hardware, hardware configured to operate in accordance with the Bluetooth wireless communication protocol, and/or any wired or wireless hardware for communicating with other networks and/or devices.

It should now be understood that the embodiments described herein are directed to methods of analyzing and visualizing airfoil blend limits as dictated by aeromechanical requirements and methods for probabilistic high cycle fatigue assessment on turbomachinery airfoils accounting for variation in airfoil geometry, systemic geometry, material strength, analysis methods and damping.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses:

1. A method of generating a blend design space visualization for use in blending a damaged airfoil, the method comprising: generating, using a computing system, a plurality of simulated blended airfoil designs, each comprising one of a plurality of blend geometries; generating, using the computing system, training data regarding a natural frequency, a modal force, and a Goodman scale factor of the plurality of simulated blended airfoil designs; training, using the computing system, surrogate models representing a blend design space based on the training data; determining, using the computing system, a likelihood of operational failure throughout the blend design space in response to one or more vibratory modes using the surrogate models; determining, using the computing system, one or more regions of the blend design space that violate at least one aeromechanical constraint; generating, using the computing system, a blend design space visualization of the blend design space; and providing, by the computing system, the blend design space visualization to an external system for use in blending a damaged airfoil to form a blended airfoil.

2. The method of any preceding clause, wherein the blend design space visualization comprises one or more restricted regions indicating one or more blended airfoil designs where the at least one aeromechanical constraint is violated and one or more permitted regions indicating one or more blended airfoil designs where no aeromechanical constraints are violated.

3. The method of any preceding clause, further comprising blending the damaged airfoil based on a simulated blended airfoil design outside of the one or more regions of the blend design space that violate the at least one aeromechanical constraint to form the blended airfoil.

4. The method of any preceding clause, wherein the blend design space comprises at least two blend parameters.

5. The method the fourth clause, wherein a first blend parameter comprises a radial location of a blended region between a tip end and a hub end of the blended airfoil and a second blend parameter comprises a depth of the blended region.

6. The method of the fourth clause or the fifth clause, wherein the blend design space visualization is interactive such that the at least one aeromechanical constraint and the at least two blend parameters are adjustable.

7. The method of any preceding clause, wherein determining the one or more regions of the blend design space that violate the at least one aeromechanical constraint is a probabilistic determination and the blend design space visualization is a probabilistic blend design space comprising a contour plot depicting a probability of violation of the at least one aeromechanical constraint.

8. The method of any preceding clause further comprising determining a vibratory response as a percentage of material capability throughout the blend design space in response to the one or more vibratory modes by generating statistical distributions on a damping parameter (Q), a mistuning amplification parameter (kᵥ), a non-uniform vane spacing factor parameter (Kₙᵤᵥₛ), and an aero-scaling factor parameter (Pₛ), such that the vibratory response as a percentage of material capability is calculated by performing a Monte Carlo analysis using the equation

$$\frac{{F}_{modal} Q}{{( 2 π f )}^{2}} ( {P}_{s} {k}_{v} {k}_{nuvs} ) \frac{1}{GSF} ,$$

where F_{modal} is the modal force, f is the natural frequency, and GSF is the Goodman scale factor.

9. The method of any preceding clause, wherein the blend design space visualization visualizes the blend design space for a single vibratory mode.

10. The method of any preceding clause, wherein the blend design space visualization visualizes the blend design space for a plurality of vibratory modes.

11. The method of any preceding clause, wherein the at least one aeromechanical constraint is based on a change in natural frequency from an original airfoil design, an endurance limit, and a change in the endurance limit from the original airfoil design.

12. A method of generating a probabilistic distribution of a likelihood of high cycle fatigue failure for use in manufacturing an airfoil, the method comprising: generating, using a computing system, a plurality of simulated airfoil designs, each comprising one of a plurality of airfoil geometries; generating, using the computing system, training data regarding a natural frequency, a modal force, and a Goodman scale factor of the plurality of simulated airfoil designs; training, using the computing system, surrogate models representing an airfoil design space based on the training data; generating, using the computing system, a probabilistic distribution of an airfoil vibratory response of the airfoil design space using the surrogate models; generating, using the computing system, a probabilistic distribution of a high cycle fatigue capability of a material of the airfoil; comparing, using the computing system, the probabilistic distribution of the airfoil vibratory response and the probabilistic distribution of the high cycle fatigue capability of the material to generate a probabilistic distribution of a likelihood of high cycle fatigue failure of the airfoil design space in response to one or more vibratory modes; and providing, by the computing system, data corresponding to the likelihood of high cycle fatigue failure to an external device for the use in manufacturing the airfoil.

13. The method of the twelfth clause, further comprising manufacturing the airfoil comprising an airfoil geometry having the likelihood of high cycle fatigue failure below a failure threshold that is based on a threshold endurance limit of the airfoil geometry.

14. The method of any of the twelfth clause or the thirteenth clause, wherein generating a probabilistic distribution of the airfoil vibratory response of the airfoil design space further comprises generating statistical distributions on a damping parameter (Q), a mistuning amplification parameter (kᵥ), a non-uniform vane spacing factor parameter (Kₙᵤᵥₛ), and an aero-scaling factor parameter (Pₛ), such that a vibratory response as a percentage of material capability of the airfoil design space is calculated by performing a Monte Carlo analysis using the equation

$$\frac{{F}_{modal} Q}{{( 2 π f )}^{2}} ( {P}_{s} {k}_{v} {k}_{nuvs} ) \frac{1}{GSF} ,$$

where F_{modal} is the modal force, f is the natural frequency, and GSF is the Goodman scale factor.

15. The method of any of the twelfth through the fourteenth clause, further comprising calibrating the damping parameter (Q), the mistuning amplification parameter (kᵥ), the non-uniform vane spacing factor parameter (Kₙᵤᵥₛ), and the aero-scaling factor parameter (Pₛ) using Bayesian probabilistic tuning.

16. The method of any of the twelfth through the fifteenth clause, further comprising determining, using the computing system, a relative impact of each of a plurality of geometrical parameters of the plurality of simulated airfoil designs and a plurality of systemic variables on the likelihood of high cycle fatigue failure of the plurality of simulated airfoil designs.

17. The method of the sixteenth clause, wherein the plurality of systemic variables comprise axial gap and tip clearance.

18. A method of determining a likelihood of operational failure for use in airfoil processing, the method comprising: generating, using a computing system, a plurality of simulated airfoil designs, each comprising one of a plurality of airfoil geometries; generating, using the computing system, training data regarding a natural frequency, a modal force, and a Goodman scale factor of the plurality of simulated airfoil designs; training, using the computing system, surrogate models representing the plurality of simulated airfoil designs based on the training data; determining, using the computing system, a likelihood of operational failure of each of the plurality of simulated airfoil designs in response to one or more vibratory modes; and providing, by the computing system, data corresponding to the likelihood of operational failure to an external device for the use in airfoil processing.

19. The method of the eighteenth clause, wherein: the plurality of simulated airfoil designs comprise a plurality of simulated blended airfoil designs each comprising one of a plurality of blend geometries; and the data corresponding to the likelihood of operational failure is provided to the external device for use in blending a damaged airfoil.

20. The method of the eighteenth clause, wherein: the likelihood of operational failure is determined by comparing, using the computing system, a probabilistic distribution of airfoil vibratory response of an airfoil design space with a probabilistic distribution of a high cycle fatigue capability of a material of an airfoil to generate a probabilistic distribution of a likelihood of high cycle fatigue failure of the airfoil design space in response to the one or more vibratory modes; and the data corresponding to the likelihood of operational failure is provided to the external device for use in manufacturing the airfoil.

21. A system, comprising: a processor; and a non-transitory, processor-readable storage medium comprising one or more programming instructions thereon that, when executed, cause the processor to: generate a plurality of simulated blended airfoil designs, each comprising one of a plurality of blend geometries; generate training data regarding a natural frequency, a modal force, and a Goodman scale factor of the plurality of simulated blended airfoil designs; train surrogate models representing a blend design space based on the training data; determine a likelihood of operational failure throughout the blend design space in response to one or more vibratory modes using the surrogate models; determine one or more regions of the blend design space that violate at least one aeromechanical constraint; generate a blend design space visualization of the blend design space; and provide the blend design space visualization to an external system for use in blending a damaged airfoil to form a blended airfoil.

22. The system of the twenty-first clause, wherein the blend design space visualization comprises one or more restricted regions indicating one or more blended airfoil designs where the at least one aeromechanical constraint is violated and one or more permitted regions indicating one or more blended airfoil designs where no aeromechanical constraints are violated.

23. The system of the twenty-first clause or the twenty-second clause, wherein the blend design space comprises a first blend parameter comprising a radial location of a blended region between a tip end and a hub end of a blended airfoil and a second blend parameter comprises a depth of the blended region.

24. The system of any of the twenty-first through the twenty-third clause, wherein the at least one aeromechanical constraint is based on a change in natural frequency from an original airfoil design, an endurance limit, and a change in the endurance limit from the original airfoil design.

25. A system, comprising: a processor; and a non-transitory, processor-readable storage medium comprising one or more programming instructions thereon that, when executed, cause the processor to: generate a plurality of simulated airfoil designs, each comprising one of a plurality of airfoil geometries; generate training data regarding a natural frequency, a modal force, and a Goodman scale factor of the plurality of simulated airfoil designs; train surrogate models representing an airfoil design space based on the training data; generate a probabilistic distribution of an airfoil vibratory response of the airfoil design space using the surrogate models; generate a probabilistic distribution of a high cycle fatigue capability of a material of the airfoil; compare the probabilistic distribution of the airfoil vibratory response and the probabilistic distribution of the high cycle fatigue capability of the material to generate a probabilistic distribution of a likelihood of high cycle fatigue failure of the airfoil design space in response to one or more vibratory modes; and provide data corresponding to the likelihood of high cycle fatigue failure to an external device for the use in manufacturing the airfoil.

What is claimed is:

1. A method of generating a blend design space visualization for use in blending a damaged airfoil, the method comprising:
generating, using a computing system, a plurality of simulated blended airfoil designs, each comprising one of a plurality of blend geometries;
generating, using the computing system, training data regarding a natural frequency, a modal force, and a Goodman scale factor of the plurality of simulated blended airfoil designs;
training, using the computing system, surrogate models representing a blend design space based on the training data;
determining, using the computing system, a likelihood of operational failure throughout the blend design space in response to one or more vibratory modes using the surrogate models;
determining, using the computing system, one or more regions of the blend design space that violate at least one aeromechanical constraint;
generating, using the computing system, a blend design space visualization of the blend design space; and
providing, by the computing system, the blend design space visualization to an external system for use in blending a damaged airfoil to form a blended airfoil.

2. The method of claim 1, wherein the blend design space visualization comprises one or more restricted regions indicating one or more blended airfoil designs where the at least one aeromechanical constraint is violated and one or more permitted regions indicating one or more blended airfoil designs where no aeromechanical constraints are violated.

3. The method of claim 1, further comprising blending the damaged airfoil based on a simulated blended airfoil design outside of the one or more regions of the blend design space that violate the at least one aeromechanical constraint to form the blended airfoil.

4. The method of claim 1, wherein the blend design space comprises at least two blend parameters.

5. The method of claim 4, wherein a first blend parameter comprises a radial location of a blended region between a tip end and a hub end of the blended airfoil and a second blend parameter comprises a depth of the blended region.

6. The method of claim 4, wherein the blend design space visualization is interactive such that the at least one aeromechanical constraint and the at least two blend parameters are adjustable.

7. The method of claim 1, wherein determining the one or more regions of the blend design space that violate the at least one aeromechanical constraint is a probabilistic determination and the blend design space visualization is a probabilistic blend design space comprising a contour plot depicting a probability of violation of the at least one aeromechanical constraint.

8. The method of claim 1, further comprising determining a vibratory response as a percentage of material capability throughout the blend design space in response to the one or more vibratory modes by generating statistical distributions on a damping parameter (Q), a mistuning amplification parameter (kᵥ), a non-uniform vane spacing factor parameter (Kₙᵤᵥₛ), and an aero-scaling factor parameter (Pₛ), such that the vibratory response as a percentage of material capability is calculated by performing a Monte Carlo analysis using the equation
$$\frac{{F}_{modal} Q}{{( 2 π f )}^{2}} ( {P}_{s} {k}_{v} {k}_{nuvs} ) \frac{1}{GSF} ,$$
where F_{modal} is the modal force, f is the natural frequency, and GSF is the Goodman scale factor.

9. The method of claim 1, wherein the blend design space visualization visualizes the blend design space for a single vibratory mode.

10. The method of claim 1, wherein the blend design space visualization visualizes the blend design space for a plurality of vibratory modes.

11. The method of claim 10, wherein the at least one aeromechanical constraint is based on a change in natural frequency from an original airfoil design, an endurance limit, and a change in the endurance limit from the original airfoil design.

12. A method of generating a probabilistic distribution of a likelihood of high cycle fatigue failure for use in manufacturing an airfoil, the method comprising:
generating, using a computing system, a plurality of simulated airfoil designs, each comprising one of a plurality of airfoil geometries;
generating, using the computing system, training data regarding a natural frequency, a modal force, and a Goodman scale factor of the plurality of simulated airfoil designs;
training, using the computing system, surrogate models representing an airfoil design space based on the training data;
generating, using the computing system, a probabilistic distribution of an airfoil vibratory response of the airfoil design space using the surrogate models;
generating, using the computing system, a probabilistic distribution of a high cycle fatigue capability of a material of the airfoil;
comparing, using the computing system, the probabilistic distribution of the airfoil vibratory response and the probabilistic distribution of the high cycle fatigue capability of the material to generate a probabilistic distribution of a likelihood of high cycle fatigue failure of the airfoil design space in response to one or more vibratory modes; and
providing, by the computing system, data corresponding to the likelihood of high cycle fatigue failure to an external device for the use in manufacturing the airfoil.

13. The method of claim 12, further comprising manufacturing the airfoil comprising an airfoil geometry having the likelihood of high cycle fatigue failure below a failure threshold that is based on a threshold endurance limit of the airfoil geometry.

14. The method of claim 12, wherein generating a probabilistic distribution of the airfoil vibratory response of the airfoil design space further comprises generating statistical distributions on a damping parameter (Q), a mistuning amplification parameter (kᵥ), a non-uniform vane spacing factor parameter (Kₙᵤᵥₛ), and an aero-scaling factor parameter (Pₛ), such that a vibratory response as a percentage of material capability of the airfoil design space is calculated by performing a Monte Carlo analysis using the equation
$$\frac{{F}_{modal} Q}{{( 2 π f )}^{2}} ( {P}_{s} {k}_{v} {k}_{nuvs} ) \frac{1}{GSF} ,$$
where F_{modal} is the modal force, f is the natural frequency, and GSF is the Goodman scale factor.

15. The method of claim 14, further comprising calibrating the damping parameter (Q), the mistuning amplification parameter (kᵥ), the non-uniform vane spacing factor parameter (Kₙᵤᵥₛ), and the aero-scaling factor parameter (Pₛ) using Bayesian probabilistic tuning.

16. The method of claim 12, further comprising determining, using the computing system, a relative impact of each of a plurality of geometrical parameters of the plurality of simulated airfoil designs and a plurality of systemic variables on the likelihood of high cycle fatigue failure of the plurality of simulated airfoil designs.

17. The method of claim 16, wherein the plurality of systemic variables comprise axial gap and tip clearance.

18. A method of determining a likelihood of operational failure for use in airfoil processing, the method comprising:
generating, using a computing system, a plurality of simulated airfoil designs, each comprising one of a plurality of airfoil geometries;
generating, using the computing system, training data regarding a natural frequency, a modal force, and a Goodman scale factor of the plurality of simulated airfoil designs;
training, using the computing system, surrogate models representing the plurality of simulated airfoil designs based on the training data;
determining, using the computing system, a likelihood of operational failure of each of the plurality of simulated airfoil designs in response to one or more vibratory modes; and
providing, by the computing system, data corresponding to the likelihood of operational failure to an external device for the use in airfoil processing.

19. The method of claim 18, wherein:
the plurality of simulated airfoil designs comprise a plurality of simulated blended airfoil designs each comprising one of a plurality of blend geometries; and
the data corresponding to the likelihood of operational failure is provided to the external device for use in blending a damaged airfoil.

20. The method of claim 18, wherein:
the likelihood of operational failure is determined by comparing, using the computing system, a probabilistic distribution of airfoil vibratory response of an airfoil design space with a probabilistic distribution of a high cycle fatigue capability of a material of an airfoil to generate a probabilistic distribution of a likelihood of high cycle fatigue failure of the airfoil design space in response to the one or more vibratory modes; and
the data corresponding to the likelihood of operational failure is provided to the external device for use in manufacturing the airfoil.
